(19) United States
(12) Patent Application Publication
(10) Pub. No.: US 2007/0189304 A1
(43) Pub. Date: Aug. 16, 2007

(54) MAC-driven transport block size selection at a physical layer

(75) Inventor: Claudio Rosa, Randers (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/698,128

(22) Filed: Jan. 26, 2007

Related U.S. Application Data
(60) Provisional application No. 60/762,511, filed on Jan. 27, 2006.

(51) Int. Cl. H04L 12/56; H04L 12/28

(52) U.S. Cl. 370/395.21; 370/395.4

(57) ABSTRACT

A network component for performing packet scheduling functions, the network component includes a medium access component and a physical component. The medium access component pre-calculates a set of transport blocks sizes based on predefined parameters and measurements for logical channel identifiers associated with a radio link identifier and signals the set of pre-calculated transport block sizes with a priority indicator to the physical component. The physical component selects one of the transport blocks in the set of transport blocks. The selection of a near optimum transport block size at the physical component is enabled for a certain amount of allocated physical resources.

### CROSS-REFERENCES TO RELATED APPLICATIONS

This application claims priority of U.S. Provisional Patent Application Ser. No. 60/762,511, filed on Jan. 27, 2006. The subject matter of the above referenced application is incorporated by reference.

### BACKGROUND OF THE INVENTION

1. Field of the Invention

The present invention relates to Universal Mobile Telecommunications System (UTMS) base station scheduling implementation, and in particular, to a selection of a transport block size for the transmission of Layer 2 user data and control plane data in the downlink of a novel Evolved UTRAN (E-UTRAN) system.

2. Description of the Related Art

In 3.9G cellular networks, Medium Access Control (MAC) segments from different logical channel flows may be multiplexed to the same transport block. Examples of these 3.9G cellular networks include a cellular network providing long term evolution of UTMS Terrestrial Radio Access Network (UTRA) in 3^{rd} Generation Partnership Project (3GPP) UMTS. In UTMS, a transport block is defined as the data accepted by a physical layer (PHY) to be jointly encoded. 3.9G cellular networks also support variable MAC segment size for each logical channel flow. This approach provides greater flexibility to the 3.9G cellular networks, although the header sizes in such systems are increased. The header sizes might even have different values. In addition, this approach also increases the complexities of synchronization between the selection of the transport block size at the PHY and the segmentation functionality at the MAC, as the PHY layer will not know the header size allocated to each MAC segment.

In current 3.9G packet scheduling systems, the packet scheduling functions are divided between the PHY and MAC. The PHY selects the transport block size for each Radio Link Identifier based on the resources available for transmission, for example, time-frequency, power, Channel Quality Indicator, etc. PHY also receives inputs from MAC, which on the other hand has full knowledge of the data buffers and is responsible for Quality of Service control. In a current 3.9G packet scheduling system, for every scheduling period, and for each Radio Link Identifier in the scheduling candidate set, the MAC signals to the PHY a set of scheduling parameters. Specifically, the MAC signals the minimum data amount that needs to be transmitted, additional data amount that can potentially be transmitted should there be any extra capacity after the minimum data amount has been scheduled for all Radio Link Identifiers in a scheduling candidate set, and scheduling priority that is used to prioritize between the Radio Link Identifiers. Based on optimization criteria that depend on a particular scheduling policy, the PHY selects a transport block size that is lower-bounded by the minimum data amount that needs to be transmitted and upper-bounded by the addition of the minimum data amount and the additional data amount that can potentially be transmitted should there be any extra capacity after the minimum data amount has been scheduled for all Radio Link Identifiers in the scheduling candidate set. However, at the PHY, it is not possible to know whether or not the selected transport block size is such that the MAC can optimize segmentation and consequently maximize Layer 3 throughput.

### BRIEF SUMMARY OF THE INVENTION

A network component for performing packet scheduling functions, the network component includes a medium access component and a physical component. The medium access component pre-calculates a set of transport blocks sizes based on predefined parameters and measurements for logical channel identifiers associated with a radio link identifier and signals the set of pre-calculated transport block sizes with a priority indicator to the physical component. The medium access component may signal the set of pre-calculated transport block sizes to a packet scheduler. The physical component selects one of the transport blocks in the set of transport blocks. The selection of a near optimum transport block size at the physical component is enabled for a certain amount of allocated physical resources.

Another embodiment of the invention is directed to a medium access component of a network performing packet scheduling functions, the medium access component includes a unit configured to pre-calculate a set of transport blocks sizes based on predefined parameters and measurements for logical channel identifiers associated with a radio link identifier. The medium access component also includes a unit configured to signal the set of pre-calculated transport block sizes with a priority indicator to a physical component. The medium access component may signal the set of pre-calculated transport block sizes to a packet scheduler. The physical component selects one of the transport blocks in the set of transport blocks, thereby enabling the selection of a near optimum transport block size at the physical component for a certain amount of allocated physical resources.

An embodiment of the invention is also directed to a physical component of a network performing packet scheduling functions, the physical component includes a receiving unit configured to receive from a medium access component a pre-calculated set of transport blocks sizes based on predefined parameters and measurements for logical channel identifiers associated with a radio link identifier. The medium access component signals the set of pre-calculated transport block sizes with a priority indicator to the physical component. The physical component also includes a selecting unit configured to select one of the transport blocks in the set of transport blocks. The selection of a near optimum transport block size at the physical component is enabled for a certain amount of allocated physical resources.

Another embodiment of the invention is directed to a method including pre-calculating a set of transport blocks sizes based on predefined parameters and measurements for logical channel identifiers associated with a radio link identifier. The method also includes signaling the set of pre-calculated transport block sizes with a priority indicator to a physical component or signaling the set of pre-calculated transport block sizes to a packet scheduler. The method also includes selecting one of the transport blocks in the set of transport blocks, wherein a selection of a near optimum transport block size at the physical component is enabled for a certain amount of allocated physical resources.

Another embodiment of the invention is directed to an apparatus for performing packet scheduling functions, the apparatus includes means for pre-calculating a set of transport blocks sizes based on predefined parameters and measurements for logical channel identifiers associated with a radio link identifier and for signaling the set of pre-calculated transport block sizes with a priority indicator to a physical component or signaling the set of pre-calculated transport block sizes to a packet scheduler. The apparatus also includes means for selecting one of the transport blocks in the set of transport blocks. The selection of a near optimum transport block size at the physical component is enabled for a certain amount of allocated physical resources.

Another embodiment of the invention is directed to a computer program product embodied on a computer readable medium, the computer program product includes instructions for performing the steps of pre-calculating a set of transport blocks sizes based on predefined parameters and measurements for logical channel identifiers associated with a radio link identifier, signalling the set of pre-calculated transport block sizes with a priority indicator to a physical component or signaling the set of pre-calculated transport block sizes to a packet scheduler. The apparatus also includes selecting one of the transport blocks in the set of transport blocks. The selection of a near optimum transport block size at the physical component is enabled for a certain amount of allocated physical resources.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates a Universal Mobile Telecommunications System (UMTS) system architecture in which an embodiment the present invention may be implemented;

FIG. 2 illustrates the structure of a UTRA/UTRAN in which an embodiment of the present invention is implemented;

FIG. 3 illustrates a current 3.9G packet scheduling systems in which packet scheduling functions are divided between the physical layer and MAC;

FIG. 4 illustrates a 0.9G packet scheduling systems in which the MAC pre-calculates a set of transport block sizes and sends them to the physical layer;

FIG. 5 illustrates an embodiment of the invention with a Radio Link Identifier having three different logical channel identifiers;

FIG. 6 illustrates an example of a possible transport block size set that is signalled from MAC to the physical layer base on the illustrations of FIG. 5;

FIG. 7 illustrates a list of transport block sizes signalled from MAC 208 to PHY 202 based on the illustrations of FIG. 3;

FIG. 8 illustrates scheduling data indicators signalled from MAC 208 to PHY 202 based on the illustrations of FIG. 3; and

FIG. 9 illustrates the steps implemented in an embodiment of the invention.

### DETAILED DESCRIPTION OF PREFERRED EMBODIMENTS OF THE INVENTION

Reference will now be made to the preferred embodiments of the present invention, examples of which are illustrated in the accompanying drawings.

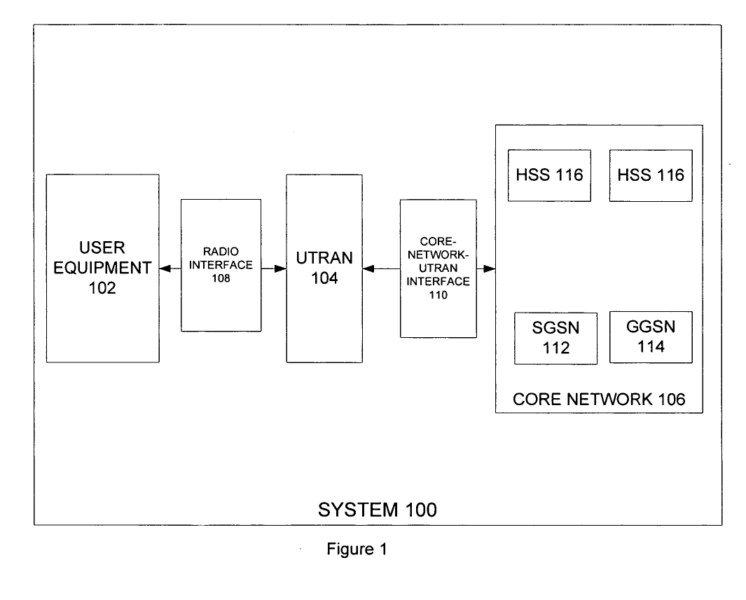

FIG. 1 illustrates a Universal Mobile Telecommunications System (UMTS) system architecture 100 in which an embodiment of the present invention is implemented. System 100 includes a user equipment 102, a UMTS Terrestrial Radio Access Network (UTRA/UTRAN) 104 and a Core Network 106. A radio interface 108 connects user equipment 102 with UTRAN 104 and a core network-UTRAN interface 110 connects UTRAN 104 with core network 106. As is known to those of ordinary skill in the art, user equipment encompasses a variety of equipment types with different levels of functionality. User equipment 102 may include a removable smart card that may be used in different user equipment types. UTRAN 104 includes entities which provide the user of user equipment 102 with a mechanism to access core network 106. Core network 106 includes entities which provide support for network features and telecommunications services, such as management of the user location, control of network features and services, and switching and transmission mechanisms for signalling and user generated information. In an embodiment, the core network includes a Serving GPRS Support Node (SGSN) 112 for network access support and mobility management, a Gateway GPRS Support Nodes (GGSN) 114 for access to service areas over IP packet data networks, a Home Subscriber Server (HSS) 116 for user identification, security, location, and preferences, and a Call State Control Function (CSCF) 118 which is a SIP server that supports and controls multimedia sessions for IP terminals, routes incoming calls, call state management, user profiling and address handling.

The present invention is implemented in a 3^{rd} Generation Partnership Project (3GPP) radio access network and functions to meet the Evolved UMTS Terrestrial Radio Access and Evolved UMTS Terrestrial Radio Access Network (E-UTRA and UTRAN) requirements. To ensure the competitiveness of 3GPP radio access network technology, an E-UTRA and UTRAN framework is being developed for the evolution of 3GPP radio-access technology towards a high-data rate, low latency and packet optimized radio access technology. The E-UTRA and UTRAN air interface is being designed to support both frequency division duplex (FDD) and time division duplex (TDD) modes of operation. The E-UTRA and UTRAN interface is designed, for FDD, to support simultaneous uplink/downlink in different frequency bands, and to support non-simultaneous uplink/downlink in the same frequency band, for TDD. The E-UTRA and UTRAN interface is also designed to consider FDD extension to combine FDD/TDD, wherein the E-UTRA and UTRAN interface supports non-simultaneous uplink/downlink in different frequency bands and simplify multi-band terminals.

Some key requirements of the E-UTRA and UTRAN design in the downlink direction are good link performance in diverse channel conditions, good system performance, low transmission delay, well-matched to multi-antenna techniques including MIMO, efficient broadcast, and spectrum flexibility, among others. The key uplink related requirements and their implications of the E-UTRA and UTRAN design are good coverage, low delay, low cost terminal and long battery life, unnecessary base station complexity, and possibility for orthogonal intra-cell and inter-cell interference reduction. The E-UTRA and UTRAN thus seeks to improve current UTRAN with notably reduced complexity and increased flexibility. It should be noted that while the system illustrated above shows a network including E-UTRA and UTRAN, the present invention is not limited to a network including E-UTRA and UTRAN. In fact the present invention may be implemented in any evolution of a network including E-UTRA and UTRAN and/or any fixed network.

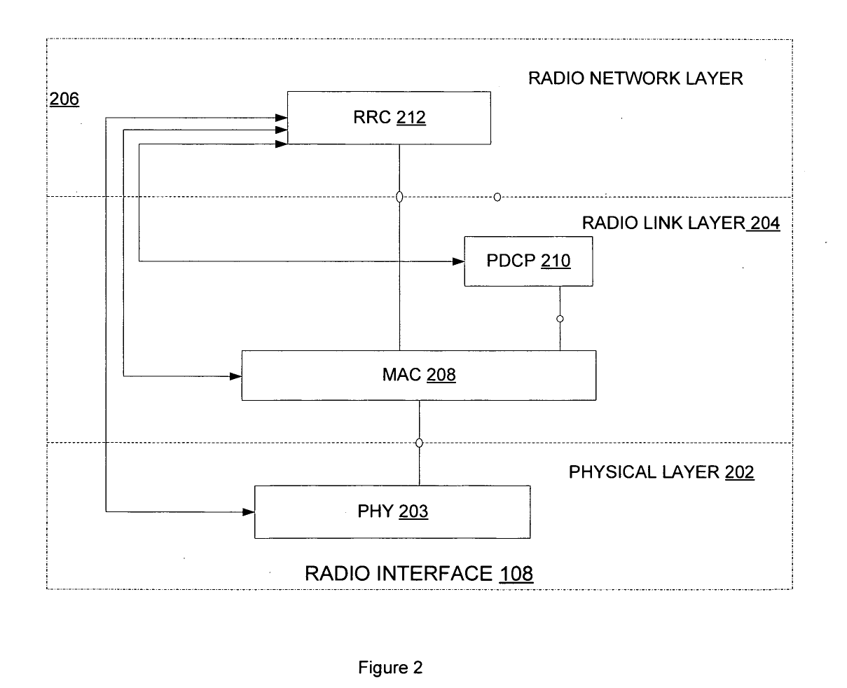

FIG. 2 illustrates the structure of E-UTRA and UTRAN 104 in which an embodiment of the present invention is implemented. As illustrated in FIG. 2, that the E-UTRA and UTRAN 104 is organized into the physical layer/Layer 1 (PHY) 202, the radio link layer/Layer 2 204, and the radio network layer/Layer 3 206. Physical layer 202 includes a PHY component 203 which offers information transfer services to a MAC sublayer 208 in radio link layer 204. Specifically, physical layer 202 transport services are transport channels that are described by how and with what characteristics data are transferred over radio interface 108. Specifically, physical layer 202 performs macrodiversity distribution/combining and soft handover execution, error detection on transport channels, and indications to higher layers, among other functions.

Radio link layer 204 can include Medium Access Control (MAC) 208 and Packet Data Convergence Protocol (PDCP) 210, wherein the functions and services of radio link layer 108 are distributed to MAC 208 and PDCP 210. Radio link layer 204 can be divided into control and user planes, wherein the control plane includes MAC 208 and the user plane include MAC 208 and PDCP 210. In the user plane, PDCP 210 can interface with MAC 208 directly and includes improved support for IP based Quality of Service realization and implementation. Some of the main functions of MAC 208 include mapping between logical channels and transport channels, multiplexing/demultiplexing of upper layer packet data unit (PDU) of segmented MAC SDUs into and/or from transport blocks delivered to and/or from physical layer 202 on transport channels, traffic volume management, priority handling between data flows, priority handling between user equipments by means of dynamic scheduling, and service access class selection. In an alternate embodiment of the invention, the set of transport blocks is delivered to delivered to a packet scheduler in layer 2.

Radio network layer 206 includes a radio resource control (RRC) protocol 212 which belongs to the control plane. RRC 212 interfaces with radio link layer 204 and terminates with E-UTRA and UTRAN 104. Specifically, RRC 212 interfaces with PDCP 210, MAC 208 and physical layer 202. RRC 212 handles control plane signaling of layer 3 between user equipment 102 and E-UTRA and UTRAN 104. Some of the main functions of RRC 212 includes broadcast of core network system information and radio access network system information, connection management including establishment, re-establishment, maintenance and release between user equipment 102 and E-UTRA and UTRAN 104, configuration of radio link service profiles, allocation of layer 2 identifiers between user equipment 102 and E-UTRA and UTRAN 104, configuration of radio resources for RRC connection and traffic flows for common and shared resources, Quality of Service management functions, RRC mobility functions, cell selection and reselection, handover functions, paging function, measurement reporting and control of measurement reporting, cell and link status reporting, protocol state indication, security functions and RRC message integrity protection.

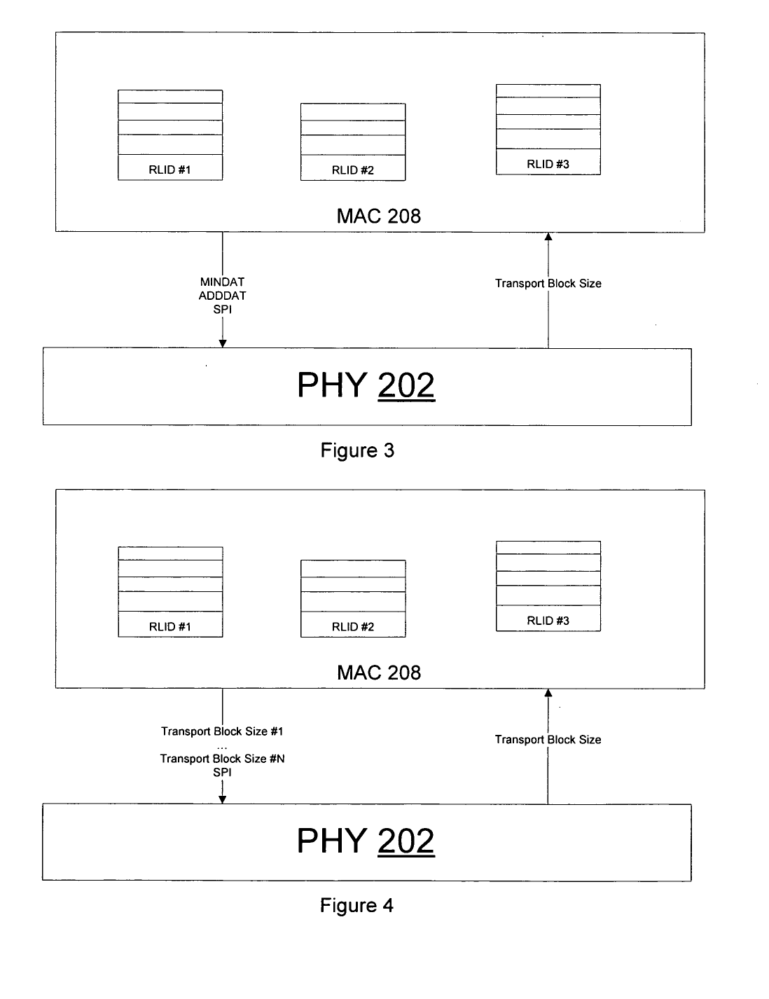

FIG. 3 illustrates a current 3.9G packet scheduling system in which packet scheduling functions are divided between the PHY 202 and MAC 208. It should be noted that in an alternate embodiment of the invention, the packet scheduling system is located only in MAC 208. PHY 202 selects the transport block size for each Radio Link Identifier based on available resources and also receives inputs from MAC 208, which has full knowledge of the data buffers and is responsible for Quality of Service control. As shown in FIG. 3, for every scheduling period, and for each Radio Link Identifier #1-3 in the scheduling candidate set, MAC 208 signals to PHY 204 the minimum data amount that needs to be transmitted (MINDAT), additional data amount that can potentially be transmitted should there be any extra capacity after the minimum data amount has been scheduled for all Radio Link Identifiers in the scheduling candidate set (ADDDAT), and scheduling priority that is used to prioritized between the Radio Link Identifiers (SPI). Based on optimization criteria, PHY 202 selects a transport block size that is lower-bounded by the minimum data amount that needs to be transmitted and upper-bounded by the minimum data amount and the additional data amount that can potentially be transmitted should there be any extra capacity after the minimum data amount has been scheduled for all Radio Link Identifiers in the scheduling candidate set.

In an embodiment of the present invention, as shown in FIG. 4, MAC 208 pre-calculates a set of transport block sizes based on the Quality of Service parameters and measurements for each logical channel identifier, the size of MAC signal data unit (SDU) in each logical channel identifier #1-3, including the different header sizes, and the overhead of potential MAC and segmentation headers. Thereafter, MAC 208 signals the set of pre-calculated transport blocks sizes #1-N to PHY 202, together with a scheduling priority indicator (SPI). As noted above, in the alternate embodiment of the invention where the packet scheduler is located in MAC 208, the transport block sizes are transmitted to the packet scheduler without the priority indicator because the quality of service information is already available at the packet scheduler. Based on optimization criteria that depend on the particular scheduling policy, PHY 202 selects one of the values in the set of transport blocks received from MAC 208. For a given amount of allocated PHY resources, such as frequency-time, power, modulation and coding, the overhead from MAC 208 and segmentation headers can be minimized.

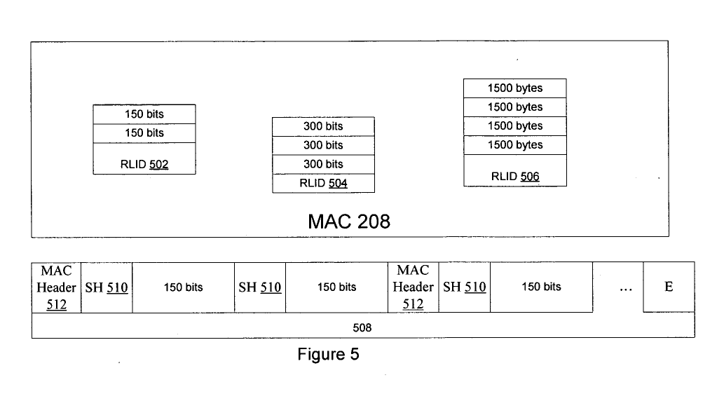

FIG. 5 illustrates an embodiment of the invention with a Radio Link Identifier having three different logical channel identifiers. Logical channel identifier 502 carries Radio Resource Control signaling, logical channel identifier 504 carries Voice Over IP (VoIP) packets and logical channel identifier 506 carries “best effort” traffic. As shown in FIG. 5, MAC SDUs from different logical channel identifiers 502-506 are multiplexed into the same transport block 508. Each MAC segment has a segmentation header (SH) 510 and for each logical channel identifier multiplexed to transport block 508, there is a generic MAC header (MH) 512.

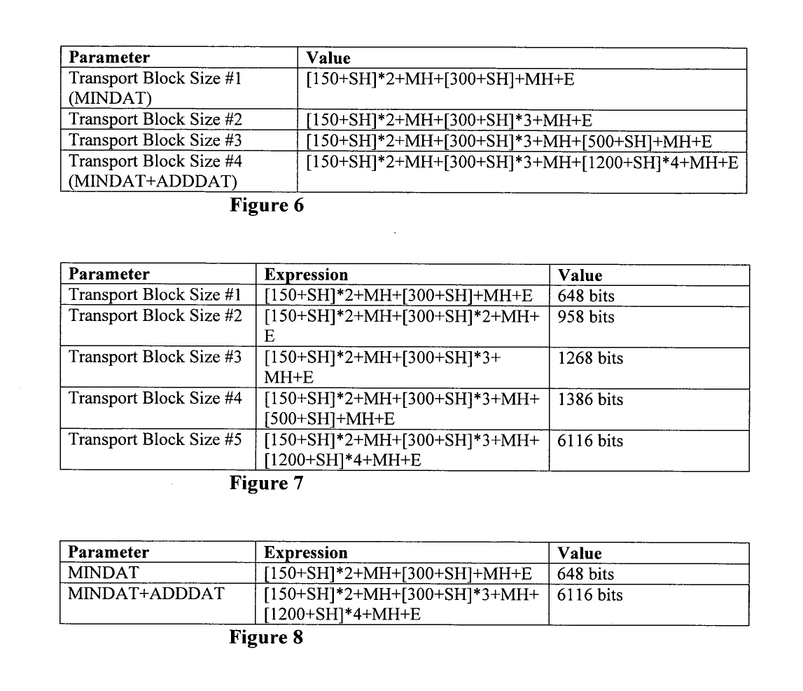

An example of a possible transport block size set that is signalled from MAC 208 to PHY 202, based on the illustrations of FIG. 5, or from MAC 208 to the packet scheduler in MAC 208 as noted in the alternate embodiment of the invention, is illustrated in FIG. 6. The first and last values in the transport block size set correspond to the minimum data amount that needs to be transmitted (MINDAT) and the addition of the minimum data amount and the additional data amount that can potentially be transmitted should there be any extra capacity after the minimum data amount has been scheduled for all Radio Link Identifiers in the scheduling candidate set, respectively (MINDAT+ADDDAT). It should be noted that the number of feasible transport block sizes can be extremely high, and in practice it is not possible for MAC 208 to pre-calculate and signal all possible values once every sub-frame. On the other hand, the overhead from MAC and segmentation headers (MH/SH) is only significant when transmitting a relatively low amount of Layer 3 data. Signalling from MAC 208 to PHY 202 the exact transport block size required for the transmission of a large amount of data might not bring any relevant gain compared to only signalling the minimum data amount that needs to be transmitted (MINDAT) and the additional data amount that can potentially be transmitted should there be any extra capacity after the minimum data amount has been scheduled for all Radio Link Identifiers in the scheduling candidate set (MINDAT+ADDDAT). Therefore, in an embodiment of the present invention, distinct transport blocks sizes are not signalled to PHY 202 when these are above a predefined threshold, except for the minimum data amount (MINDAT) and the addition of the minimum data amount and the additional data amount that can potentially be transmitted should there be any extra capacity after the minimum data amount has been scheduled for all Radio Link Identifiers in the scheduling candidate set (MINDAT+ADDDAT). This could be signalled by a special value indicating to PHY 202 to “pick any transport block size, as the overhead at MAC 208 is not significant.”

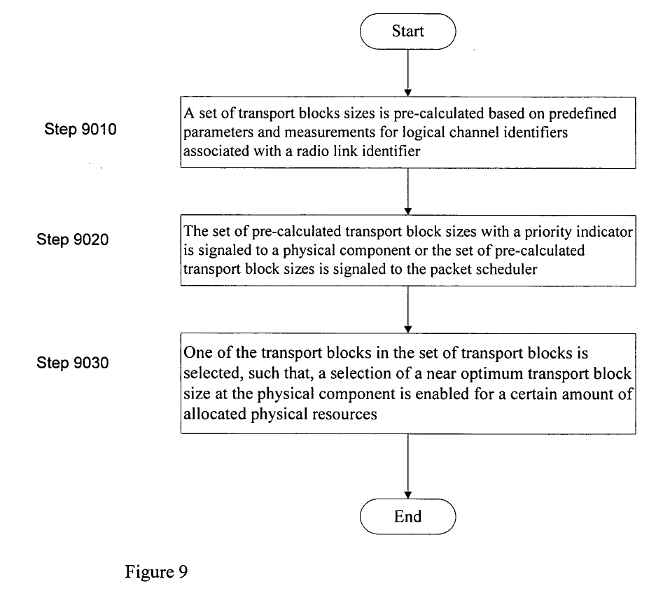

FIG. 7 illustrates a list of transport block sizes signalled from MAC 208 to PHY 202, based on the illustrations of FIG. 3 or from MAC 208 to the packet scheduler in MAC 208 as noted in the alternate embodiment of the invention. FIG. 8 illustrates scheduling data indicators signalled from MAC 208 to PHY 202, based on the illustrations of FIG. 3. It should be noted that the priority indicator is not transmitted from MAC 208 to the packet scheduler in MAC 208 as quality of service invention is available to the packet scheduler in MAC 208. In FIGS. 7 and 8, the SH is equal to 10 bits, the M1 is equal to 8 bits and the E is equal to 2 bits. Assuming that PHY 202 would allocate radio resources to the corresponding user equipment for the transmission of bits, for example 800 bits, PHY 202 will require MAC 208 to deliver a transport block of 800 bits. In previous systems, MAC 208 could use padding and deliver a transport block of 800 bits which includes 2 RRC messages of 150 bits, one VoIP packet of 300 bits, and 154 “padding” bits. This solution obviously results in a waste of radio resources. Alternatively, MAC 208 could multiplex to one transport block of 800 bits including 2 RRC messages of 150 bits, one VoIP packet of 300 bits, and 136 bits from the best effort traffic flow. With this solution, in order to maximize the utilization of the allocated PHY resources, low-priority data is prioritized over high-priority data and the overhead from Layer 2 headers cannot be controlled. By using an embodiment of the present invention, PHY 202 can either (1) increase the allocated radio resources so as to match a transport block size of 958 bits, or (2) decrease the allocated radio resources so as to match a transport block size of 648 bits. In the second case, potentially allocated radio resources may be allocated to other users for the transmission of high priority data, for example in case 1.

The present invention therefore facilitates the selection of a near-optimum transport block size at PHY 202 so that the overhead from Layer 2 headers can be minimized, for a certain amount of allocated PHY resources. The present invention may be related to air interface signalling, which could create a relation to user equipment. Furthermore, having this type of signalling provides Layer 1 with a set of “legal” transport block sizes from which to select, such that Layer 1 can optimize its resource allocation, while Layer 2 provides a solution in terms of used header overhead. The present invention also provides a novel method for communicating scheduling parameters for each Radio Link Identifier from MAC 208 to PHY 202 to the Node-B by signalling a set of transport block sizes to PHY 202 together with a scheduling priority indicator.

FIG. 9 illustrates the steps implemented in an embodiment of the invention. In Step 9010, a set of transport blocks sizes is pre-calculated based on predefined parameters and measurements for logical channel identifiers associated with a radio link identifier. In Step 9020, the set of pre-calculated transport block sizes with a priority indicator is signalled to a physical component or the set of transport block sizes is transmitted from MAC 208 to the packet scheduler in MAC 208, as noted in the alternate embodiment of the invention,. In Step 9030, one of the transport blocks in the set of transport blocks is selected, such that, a selection of a near optimum transport block size at the physical component is enabled for a certain amount of allocated physical resources.

It should be appreciated by one skilled in art, that the present invention may be utilized in any device that implements the transport block selection described above. The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

1. A network component, comprising:
a medium access component configured to pre-calculate a set of transport block sizes based on predefined parameters and measurements for logical channel identifiers associated with a radio link identifier and configured to signal the set of pre-calculated transport block sizes with a priority indicator to a physical component or to signal the set of pre-calculated transport block sizes to a packet scheduler; and
a physical component configured to select one of the transport blocks in a set of transport blocks,
wherein a selection of a near optimum transport block size at the physical component is enabled for a certain amount of allocated physical resources.

2. The network component of claim 1, wherein the medium access component is configured to pre-calculate the set of transport block sized based on at least one of Quality of Service parameters and measurements for each logical channel identifier and a size of a medium access component signal data unit in each logical channel identifier.

3. The network component of claim 1, wherein the physical component is configured to select one of the transport blocks based on optimization criteria that depend on a particular scheduling policy.

4. The network component of claim 1, wherein for a given amount of allocated physical component resources, the medium access component is configured to minimize overhead from the medium access component and segmentation headers.

5. The network component of claim 1, wherein medium access component is configured to multiplex signal data units from different logical channel identifiers into one transport block, wherein each medium access component segment comprises a segmentation header and for each logical channel identifier multiplexed into the one transport block, there is a generic medium access component header.

6. The network component of claim 1, wherein the medium access component is configured to provide a first value and a last value of the set of transport block sizes, wherein the first and last values correspond to a minimum data amount that is to be transmitted and an addition of the minimum data amount and additional data amount that can potentially be transmitted should there by any extra capacity after the minimum data amount has been scheduled for a radio link identifiers in a scheduling candidate set.

7. The network component of claim 1, wherein the medium access component is configured to signal distinct transport block sizes to one of the packet scheduler in the medium access component or the physical component when the distinct block sizes are below a predefined threshold and not to signal when above the threshold, except for a minimum data amount that is to be transmitted and an addition of the minimum data amount and additional data amount that can potentially be transmitted should there be any extra capacity after the minimum data amount has been scheduled for a radio link identifier in a scheduling candidate set.

8. The network component of claim 1, wherein the physical component is configured to increase allocated radio resources so as to match a selected transport block size.

9. The network component of claim 1, wherein the physical component is configured to decrease allocated radio resources so as to match a selected transport block size.

10. A medium access component, comprising:
a calculating unit configured to pre-calculate a set of transport block sizes based on predefined parameters and measurements for logical channel identifiers associated with a radio link identifier and to signal the set of pre-calculated transport block sizes with a priority indicator to a physical networking component or to signal the set of pre-calculated transport block sizes to a packet scheduler,
wherein the physical networking component selects one of the transport blocks in a set of transport blocks, thereby enabling a selection of a near optimum transport block size at the physical networking component for a certain amount of allocated physical resources.

11. The medium access component of claim 10, wherein the medium access component is configured to pre-calculate the set of transport block sized based on at least one of Quality of Service parameters and measurements for each logical channel identifier and a size of a medium access component signal data unit in each logical channel identifier.

12. The medium access component of claim 10, wherein for a given amount of allocated physical component resources, the medium access component is configured to minimize overhead from the medium access component and segmentation headers.

13. The medium access component of claim 10, wherein the medium access component is configured to multiplex signal data units from different logical channel identifiers into one transport block, wherein a medium access component segment comprises a segmentation header and for each logical channel identifier multiplexed into the one transport block, there is a generic medium access component header.

14. The medium access component of claim 10, wherein the medium access component is configured to provide a first value and a last value of the set of transport block sizes, wherein the first and last values correspond to a minimum data amount that is to be transmitted and an addition of the minimum data amount and additional data amount that can potentially be transmitted should there by any extra capacity after the minimum data amount has been scheduled for a radio link identifiers in a scheduling candidate set, respectively.

15. The medium access component of claim 10, wherein the medium access component is configured to signal distinct transport block sizes to one of the packet scheduler in the medium access component or the physical component when the distinct block sizes are below a predefined threshold and to not signal when above the threshold, except for a minimum data amount that is to be transmitted and an addition of the minimum data amount and additional data amount that can potentially be transmitted should there be any extra capacity after the minimum data amount has been scheduled for a radio link identifiers in a scheduling candidate set.

16. A physical networking component, comprising:
a receiving unit configured to receive, from a medium access component, a pre-calculated set of transport blocks sizes based on predefined parameters and measurements for logical channel identifiers associated with a radio link identifier, wherein the medium access component signals the set of transport block sizes with a priority indicator; and
a selecting unit configured to select one of the transport blocks in a set of transport blocks,
wherein a selection of a near optimum transport block size is enabled for a certain amount of allocated physical resources.

17. The physical networking component of claim 16, wherein the physical networking component is configured to select one of the transport blocks based on optimization criteria that depend on a particular scheduling policy.

18. The physical networking component of claim 16, wherein the physical networking component is configured to increase allocated radio resources so as to match a selected transport block size.

19. The physical networking component of claim 16, further configured to decrease allocated radio resources so as to match a selected transport block size.

20. A method, comprising:
pre-calculating a set of transport block sizes based on predefined parameters and measurements for logical channel identifiers associated with a radio link identifier;
signaling the set of transport block sizes with a priority indicator to a physical networking component or signaling the set of transport block sizes to a packet scheduler; and
selecting one of the transport blocks in a set of transport blocks,
wherein a selection of a near optimum transport block size at the physical networking component is enabled for a certain amount of allocated physical resources.

21. The method of claim 20, further comprising pre-calculating the set of transport block sizes based on at least one of Quality of Service parameters and measurements for each logical channel identifier and a size of a medium access component signal data unit in each logical channel identifier.

22. The method of claim 20, further comprising selecting one of the transport blocks based on optimization criteria that depend on a particular scheduling policy.

23. The method of claim 20, wherein for a given amount of allocated physical component resources, further comprising minimizing overhead from the medium access component and segmentation headers.

24. The method of claim 20, further comprising multiplexing signal data units from different logical channel identifiers into one transport block, wherein a medium access component segment comprises a segmentation header, and for each logical channel identifier multiplexed into the one transport block, there is a generic medium access component header.

25. The method of claim 20, further comprising providing a first value and a last value of the set of transport block sizes, wherein the first and last values correspond to a minimum data amount that is to be transmitted and an addition of the minimum data amount and additional data amount that can potentially be transmitted should there by any extra capacity after the minimum data amount has been scheduled for a radio link identifiers in a scheduling candidate set.

26. The method of claim 20, further comprising signaling distinct transport block sizes to one of the packet scheduler or the physical component when the distinct block sizes are below a predefined threshold and not to signal when above the threshold, except for a minimum data amount that is to be transmitted and an addition of the minimum data amount and additional data amount that can potentially be transmitted should there be any extra capacity after the minimum data amount has been scheduled for a radio link identifiers in a scheduling candidate set.

27. The method of claim 20, further comprising increasing allocated radio resources so as to match a selected transport block size.

28. The method of claim 20, further comprising decreasing allocated radio resources so as to match a selected transport block size.

29. An apparatus, comprising:
means for pre-calculating a set of transport block sizes based on predefined parameters and measurements for logical channel identifiers associated with a radio link identifier and for signaling the set of transport block sizes with a priority indicator or for signaling the set of transport block sizes to a packet scheduler; and
means for selecting one of the transport blocks in a set of transport blocks,
wherein the selection of a near optimum transport block size at a physical networking component is enabled for a certain amount of allocated physical resources.

30. A computer program product embodied on a computer readable medium, the computer program product comprising instructions for controlling a processor to perform:
pre-calculating a set of transport block sizes based on predefined parameters and measurements for logical channel identifiers associated with a radio link identifier;
signaling the set of pre-calculated transport block sizes with a priority indicator or for signaling the set of pre-calculated transport block sized in a packet scheduler; and
receiving selecting one of the transport blocks in a set of transport blocks,
wherein the selection of a near optimum transport block size at a physical networking component is enabled for a certain amount of allocated physical resources.
